(19) United States
(12) Patent Application Publication
(10) Pub. No.: US 2015/0340125 A1
(43) Pub. Date: Nov. 26, 2015

(54) ELECTRIC WIRE, HARNESS, ELECTRICAL CIRCUIT, FABRIC, GARMENT AND SHEET

(71) Applicant: Hitachi Metals, Ltd., Tokyo (JP)

(72) Inventors: Detian HUANG, Hitachi (JP); Takanobu WATANABE, Hitachi (JP)

(21) Appl. No.: 14/617,988

(22) Filed: Feb. 10, 2015

(30) Foreign Application Priority Data
May 22, 2014 (JP) 2014-106000

(51) Int. Cl. H01B 7/00; H01B 3/30; A47C 21/04; H05B 3/34; A41D 13/005

(52) U.S. Cl. CPC H01B 7/0009; H05B 3/342; A41D 13/0051; A47C 21/048; H01B 3/30

(57) ABSTRACT

An electric wire includes a center conductor, and an insulation layer formed on an outer periphery of the center conductor. The center conductor includes a high tensile-strength fiber and a plurality of metal strands wound around the high tensile-strength fiber.

The present application is based on Japanese patent application No. 2014-106000 filed on May 22, 2014, the entire contents of which are incorporated herein by reference.

### BACKGROUND OF THE INVENTION

1. Field of the Invention

The invention relates to an electric wire, a harness, an electrical circuit, a fabric, a garment and a sheet.

2. Description of the Related Art

In recent years, a system capable of constantly monitoring the body condition and movement of patients rapidly prevails in the medical field. The system includes an electrical circuit incorporated in clothes and bed sheets.

The electrical circuit incorporated into clothes or bed sheets may have a wiring formed of a conductive fiber or a metal fiber.

The related art to the invention of the present application may include JP-A-2010-133791.

### SUMMARY OF THE INVENTION

In case of using the conductive fiber or metal fiber as the wiring, a problem may arise that corrosion occurs in an environment constantly exposed to air or humidity and causes degradation in electrical characteristics.

In order to prevent the degradation in electrical characteristics, it is desirable to use as the wiring an electric wire (or insulated sire) having an insulation layer which is formed on the outer periphery of a center conductor.

However, the electric wire has the problem that the center conductor may be broken when it is sewn into a fabric material etc. by a sewing machine.

It is an object of the invention to provide an electric wire that is less likely to be broken when sewn into the fabric material, as well as a harness, an electrical circuit, a fabric, a garment and a sheet using the electric wire.

(1) According to one embodiment of the invention, an electric wire comprises:

a center conductor; and an insulation layer formed on an outer periphery of the center conductor,

wherein the center conductor comprises a high tensile-strength fiber and a plurality of metal strands wound around the high tensile-strength fiber.

In the above embodiment (1) of the invention, the following modifications and changes can be made.

(i) The insulation layer comprises a solid material of a fluoropolymer, and wherein the insulation layer is formed so as to be buried between the plurality of metal strands.

(2) According to another embodiment of the invention, a harness comprises:

the electric wire according to the above embodiment (1); and

a terminal component provided on at least one of end portions of the electric wire.

(3) According to another embodiment of the invention, an electrical circuit comprises a wiring comprising the electric wire according to the above embodiment (1).

(4) According to another embodiment of the invention, a fabric comprises:

a fabric material; and

the electric wire according to the above embodiment (1) that is sewn into the fabric material.

(5) According to another embodiment of the invention, a garment comprises the fabric according to the above embodiment (4) that is cut and sewn.

(6) According to another embodiment of the invention, a sheet comprises:

a sheet-shaped base material; and

the electric wire according to the above embodiment (1) that is sewn into the sheet-shaped base material.

### Effects of the Invention

According to one embodiment of the invention, an electric wire can be provided that is less likely to be broken when sewn into the fabric material, as well as a harness an electrical circuit, a fabric, a garment and a sheet using the electric wire.

### BRIEF DESCRIPTION OF THE DRAWINGS

Next, the present invention will be explained in more detail in conjunction with appended drawings, wherein:

FIG. 1 is a cross sectional view showing an electric wire in an embodiment of the present invention; and

FIG. 2 is a plan view showing a fabric using the electric wire of FIG. 1.

### DETAILED DESCRIPTION OF THE PREFERRED EMBODIMENTS

An embodiment of the invention will be described below in conjunction with the appended drawings.

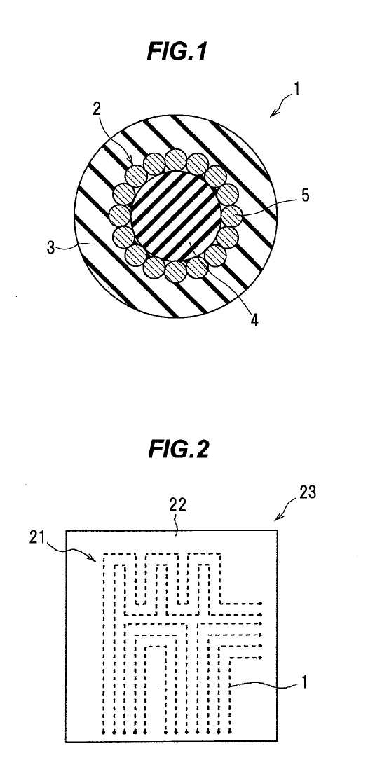

FIG. 1 is a cross sectional view showing an electric wire in the present embodiment.

As shown in FIG. 1, an electric wire 1 is formed by providing an insulation layer 3 on an outer periphery of a center conductor 2.

In the electric wire 1 of the present embodiment, the center conductor 2 is formed by spirally winding plural metal strands 5 around a high tensile-strength fiber 4.

Since the high tensile-strength fiber 4 is provided, tension applied to the electric wire 1 is imposed on the high tensile-strength fiber 4 and this allows the metal strands 5 to be prevented from being broken. The metal strands 5 are likely to be broken especially when sewing the electric wire 1 into a fabric-like material, etc., since the electric wire 1 is repeatedly bent with a small curvature radius. However, in the configuration in which the metal strands 5 are wound around the high tensile-strength fiber 4, a tensile load when sewing down the electric wire 1 is imposed on the high tensile-strength fiber 4 and this allows the metal strands 5 to be prevented from being broken.

The high tensile-strength fiber 4 desirably has a breaking strength of not less than 5 N. A polyester fiber such as aromatic polyamide fiber is preferably used as the high tensile-strength fiber 4.

A copper wire or copper alloy wire having an outer diameter of 0.01 to 0.05 mm is used as the metal strand 5. This is because the metal strand 5 with an outer diameter of less than 0.01 mm is likely to be broken, while the metal strand 5 with an outer diameter of more than 0.05 mm causes an increase in an outer diameter of the entire electric wire 1, which makes sewing work difficult. Desirably, an outer diameter of the entire center conductor 2 is not more than 0.15 mm.

A resin used to form the insulation layer 3 is desirably a fluoropolymer which is excellent in heat resistance and flex resistance and can be applied as thin as not more than 0.1 mm. As a fluoropolymer used to form the insulation layer 3, it is possible to use tetrafluoroethylene-perfluoroalkyl vinyl ether copolymer (PFA), tetrafluoroethylene-hexafluoropropylene copolymer (FEP) or ethylene-tetrafluoroethylene copolymer (ETFE), polypropylene (PP), etc. A dielectric constant and a dielectric loss tangent of the fluoropolymer are small. Therefore, it is possible to suppress an increase in dielectric loss by using the fluoropolymer as a material of the insulation layer 3.

The insulation layer 3 is formed to be filled solid and is applied so as to enter deeply between the metal strands 5. The insulation layer 3 is formed by extrusion molding. Appropriately changing the extrusion molding conditions allows the resin constituting the insulation layer 3 to reach around the metal strands 5. Since the insulation layer 3 is applied so as to enter deeply between the metal strands 5, adhesion between the insulation layer 3 and the center conductor 2 is enhanced and it is thus possible to suppress separation of the insulation layer 3 from the center conductor 2 when sewing the electric wire 1 into a material.

A harness in the present embodiment is composed of the electric wire 1 in the present embodiment and a terminal component provided on at least one of end portions of the electric wire 1. Examples of terminal component include circuit boards such as PCB (printed circuit board) or FPC (flexible printed circuit), connectors, flexible flat cables (FFC), multi frame joiners (MFJ) and sensor members, etc.

Meanwhile, in an electrical circuit 21 of the present embodiment, the electric wire 1 is used for wiring, as shown in FIG. 2. FIG. 2 shows a fabric 23 having the electrical circuit 21 which is formed by sewing the electric wire 1 into a fabric-like material 22. The electric wire 1 is sewn, with a desired shape, into the fabric-like material 22 by, e.g., a sewing machine. A garment in the present embodiment is obtained by cutting and sewing the fabric 23.

By sewing the electric wire 1 on the fabric-like material 22, the electric wire 1 is integrated with the fabric-like material 22, stress applied when bending or pulling the fabric 23 is absorbed by fibers of the fabric-like material 22 and this prevents the electric wire 1 from receiving a large stress. Therefore, it is possible to realize a user-friendly electrical circuit 21 which is easily stored, e.g., foldable.

In addition to the application for wiring of the electrical circuit 21, it is possible to use the electric wire 1 as a sensor portion which detects contact of an object with the fabric 23 based on measurement of capacitance between two electric wires 1 which are arranged in parallel.

Furthermore, forming an electrical circuit by sewing the electric wire 1 into a sheet-shaped base material provides a sheet in the present embodiment even though it is not illustrated. The sheet-shaped base material includes thin films.

Forming the electrical circuit by sewing the electric wire 1 into the sheet-shaped base material allows a flexible circuit board to be realized more easily at lower cost than conventionally used flexible printed circuit boards.

As described previously, in the electric wire 1 of the present embodiment, the center conductor 2 is formed by spirally winding plural metal strands 5 around the high tensile-strength fiber 4.

In such a configuration, tension applied to the electric wire 1 is imposed on the high tensile-strength fiber 4 and this allows the metal strands 5 to be prevented from being broken when, e.g., sewing down the electric wire 1.

The invention is not intended to be limited to the embodiment, and it is obvious that the various kinds of modifications can be implemented without departing from the gist of the invention.

What is claimed is:

1. An electric wire, comprising:
a center conductor; and
an insulation layer formed on an outer periphery of the center conductor,
wherein the center conductor comprises a high tensile-strength fiber and a plurality of metal strands wound around the high tensile-strength fiber.

2. The electric wire according to claim 1, wherein the insulation layer comprises a solid material of a fluoropolymer, and
wherein the insulation layer is formed so as to be buried between the plurality of metal strands.

3. A harness, comprising:
the electric wire according to claim 1; and
a terminal component provided on at least one of end portions of the electric wire.

4. An electrical circuit, comprising a wiring comprising the electric wire according to claim 1.

5. A fabric, comprising:
a fabric material; and
the electric wire according to claim 1 that is sewn into the fabric material.

6. A garment, comprising the fabric according to claim 5 that is cut and sewn.

7. A sheet, comprising:
a sheet-shaped base material; and
the electric wire according to claim 1 that is sewn into the sheet-shaped base material.
